(19) United States
(12) Patent Application Publication
(10) Pub. No.: US 2025/0139831 A1
(43) Pub. Date: May 1, 2025

(54) CODEC-AGNOSTIC ADAPTIVE QUANTIZATION OF IMAGES AND VIDEO USING A PIXEL-BASED PRE- AND POST-PROCESSOR

(71) Applicant: GOOGLE LLC, Mountain View, CA (US)

(72) Inventors: Jyrki Antero Alakuijala, Wollerau (CH); Matthew Sharifi, Kilchberg (CH); Zoltan Szabadka, Gyorujbarat (HU); Moritz Firsching, Basel (CH); Thomas Fischbacher, Gattikon (CH); Sami Boukortt, Zurich (CH); Martin Bruse, Tyreso (SE); Evgenii Kliuchnikov, Thalwil (CH)

(21) Appl. No.: 18/693,704

(22) PCT Filed: Jan. 27, 2023
(86) PCT No.: PCT/US2023/061473

§ 371 Date: Mar. 20, 2024

(51) Int. Cl. G06T 9/00

(52) U.S. Cl. CPC G06T 9/00

(57) ABSTRACT

A method including generating base values and delta values based on an image, generating weighted delta values based on the delta values, generating an enhanced image based on the base values and the weighted delta values, and compressing the enhanced image.

### FIELD

Implementations relate to encoding and/or decoding images and/or video (e.g., video frames).

### BACKGROUND

Quantization and deblocking filtering are techniques used in many image encoding and decoding techniques (i.e., codecs). Areas of lower contrast in an image or video may have observable details that quantization or deblocking filtering removes. Similarly, areas of very high visual activity may have less need to store exact quantization coefficients. Adaptive quantization can be used to address these two scenarios (unwanted removal of observable details and support of flexible quantization coefficients). Adaptive quantization scales the coefficients of an integral transform using side channel data (e.g., an adaptive quantization field).

### SUMMARY

Example implementations can improve the compression and decompression process by using a pre-processing technique that modifies the video frame and/or image together with a weighting scheme that can account for small transition details in the video frame and/or image. The decompression process can use an inverse modification and weighting scheme to generate a decompressed video frame and/or image that substantially includes small transition details from the original video frame and/or image.

In a general aspect, a device, a system, a non-transitory computer-readable medium (having stored thereon computer executable program code which can be executed on a computer system), and/or a method can perform a process with a method including generating base values and delta values based on an image, generating weighted delta values based on the delta values, generating an enhanced image based on the base values and the weighted delta values, and compressing the enhanced image.

Implementations can include one or more of the following features. For example, generating base values and weighted delta values based on a reconstructed image, generating delta values based on the weighted delta values, and generating a modified image based on the base values and the weighted delta values.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations and wherein:

FIG. 1 illustrates a video encoder and video decoder system according to an example implementation.

FIG. 2 illustrates a video encoder pre-processor according to an example implementation.

FIG. 3 illustrates a video decoder post-processor according to an example implementation.

FIGS. 4A, 4B, 4C, 4D, 4E, 4F, 4G, and 4H illustrate a pixel tile selection blocks according to an example implementation.

FIG. 5 illustrates a method for encoding an image according to an example implementation.

FIG. 6 illustrates a method for decoding an image according to an example implementation.

FIG. 7A illustrates a block diagram of an encoder (e.g., video and/or image) according to an example implementation.

FIG. 7B illustrates a block diagram of a decoder (e.g., video and/or image) according to an example implementation.

FIG. 8 is a block diagram of a method of encoding a video and/or image according to an example implementation.

FIG. 9 is a block diagram of a method of decoding a video and/or image according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

A problem with current video frame and/or image compression techniques is that regions with subtle texture differences in an original frame and/or image may not be present when a compressed video frame and/or image is decompressed. For example, an original frame and/or image including skin, wood, concrete, grass, and the like regions can have subtle texture differences that may not be present when a compressed frame and/or image is decompressed. As mentioned above, this can be caused by quantization and/or deblocking filtering. For example, optimizing the quantization process can include minimizing a squared error calculation between a compressed video frame and/or image and a decompressed video frame and/or image. Previously, this problem may have been solved using adaptive quantization which may also be optimized by minimizing a squared error calculation.

A problem with adaptive quantization is that one scaling value is used for the whole integral transform. By using one scaling value, areas of transition (e.g., texture changes, color changes, and the like) can lose detail due to the compression and decompression process. Example implementations can improve the compression and decompression process by using a pre-processing technique that modifies the video frame and/or image together with a weighting scheme that can account for small transition details in the video frame and/or image. The decompression process can use an inverse modification and weighting scheme to generate a decompressed video frame and/or image that substantially includes small transition details from the original video frame and/or image.

Example implementations can mitigate the effect of compressing small changes in video frame and/or image texture, color, an/or the like regardless of the codec and without auxiliary information. Example implementations can improve the quality of a decompressed video frame and/or image by reducing artifacts introduced by the codecs (e.g., quantization and deblocking filtering) that make subtle textures look artificial. For example, example implementations can minimize the squared error between original and decompressed video frame and/or image without complex computer operations.

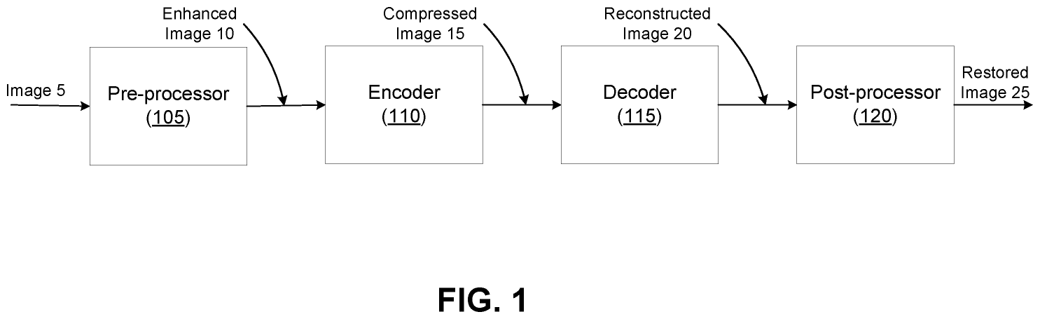

FIG. 1 illustrates a video encoder and video decoder system according to an example implementation. Noting that references to a frame of video can also apply to an image and references to an image can also apply to a frame of video. As shown in FIG. 1, the system includes a pre-processor 105, an encoder 110, a decoder 115, and a post-processor 120. The pre-processor 105 and/or the post-processor 120 can be software implementations that use the processor and memory of a device including the encoder 110 and the decoder 115. The pre-processor 105 and the post-processor 120 can be expressed as:
Image≈Image Restore (Image Enhance (Image)) . . . (1)
where:
Image Enhance is an algorithm that uses a weighting scheme to modify the Image, and
Image Restore is an inverse algorithm that uses an inverse weighting scheme to modify (restore) the Image.

The pre-processor 105 can receive an image 5 and generate an enhanced image 10. The pre-processor 105 can be configured to generate the enhanced image 10 using an algorithm and weighting scheme (discussed in more detail below). The encoder 110 can be configured to generate a compressed image 15 by compressing the enhanced image 10. The encoder 110 can be any video or image encoder (e.g., JPEG, XYB-JPEG, WebP, AVIF, JPEG XL, AV1, and the like). In other words, the pre-processor 105 and encoder 110 together can be codec-agnostic.

The decoder 115 can be configured to generate a reconstructed image 20 by decompressing the compressed image 15. The decoder 115 can be any video or image decoder (e.g., JPEG, XYB-JPEG, WebP, AVIF, JPEG XL, AV1, and the like). In other words, the post-processor 120 and decoder 115 together can be codec-agnostic. However, the encoder 110 and the decoder 115 may use the same (or substantially the same) codec. The post-processor 120 can be configured to generate a restored image 25 based on the reconstructed image. The post-processor 120 can be configured to generate the restored image 25 using an inverse algorithm and weighting scheme (discussed in more detail below).

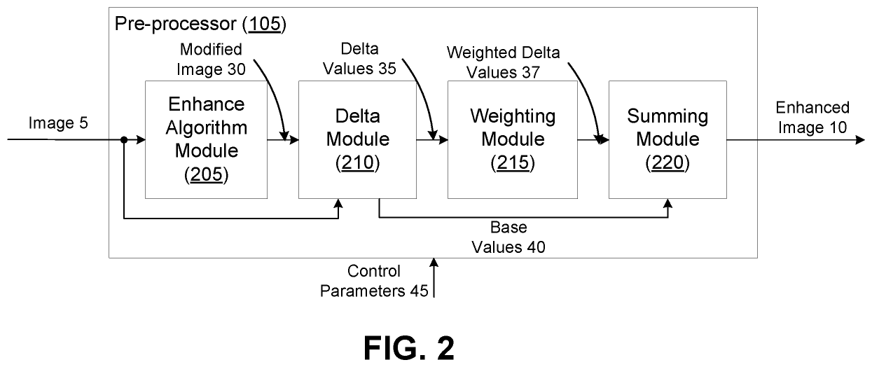

FIG. 2 illustrates the pre-processor 105 according to an example implementation. As shown in FIG. 2, the pre-processor 105 includes an enhance algorithm module 205, a delta module 210, a weighting module 215, and a summing module 220. Noting that references to a frame of video can also apply to an image and references to an image can also apply to a frame of video.

The enhance algorithm module 205 can be configured to modify the image 5 as a modified image 30. In an example implementation, the enhance algorithm module 205 can be configured to algorithmically generate a value indicating a difference between two or more pixels. For example, the enhance algorithm module 205 can be configured to use a table, a simple algorithm (e.g., a delta algorithm, a gradient algorithm, a percentage algorithm, an add/subtract algorithm, a multiply/divide algorithm, and the like), a complex algorithm (e.g., a Laplacian algorithm). The enhance algorithm module 205 can be configured to select a tile of pixels (e.g., a 4×4 tile, an 8×8 tile, . . . , a 32×32 tile and the like). The smaller the tile, the higher the quality of the restored image 25. For example, using a 2×2 tile should result in a higher quality restored image 25 than a 32×32 tile.

In an example implementation, the enhance algorithm module 205 selects an algorithm (e.g., a Laplacian algorithm) and a tile size (e.g., 4×4). Selecting the algorithm can be based on codec properties. For example, a codec that generates minimal artifacts can use a simple algorithm (e.g., a delta algorithm) and a codec that generates substantial or noticeable artifacts can use a more complex algorithm (e.g., a Laplacian algorithm). Selecting the algorithm and a tile size can be based on a control parameters 45 provided to, for example, the pre-processor (105). The control parameters 45 can include algorithm, tile size, tile selection order, codec, and the like. The enhance algorithm module 205 then applies the algorithm to each pixel in the tile. The enhance algorithm module 205 can apply the algorithm in a row-to-row pattern, a column-to-column pattern, using a pyramid pattern (e.g., do all the pixels in the outermost square of pixels and sequentially move toward the center of the tile), in a zig-zag pattern, and the like.

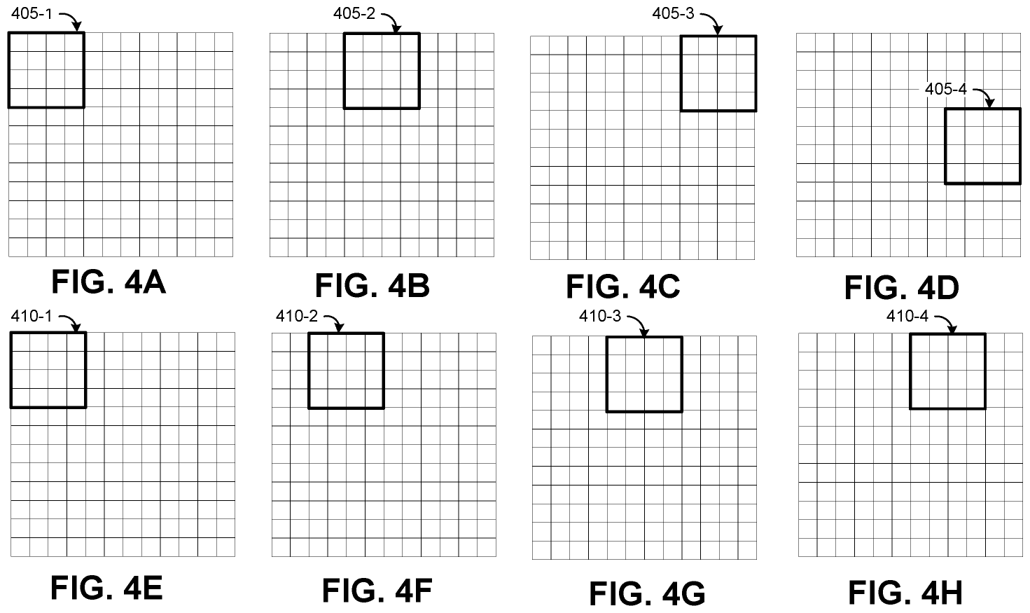

The enhance algorithm module 205 can be configured to select the next tile based on a tile selection order. For example, referring to FIGS. 4A-4D, the tile selection order is illustrated as right-to-left and left-to-right order with no overlap. For example, referring to FIGS. 4E-4H, the tile selection order is illustrated as right-to-left with a two (2) column overlap. FIGS. 4A-4H each illustrate a portion of a frame or image each including a plurality of pixels (small squares).

FIGS. 4A-4H also illustrate a tile 405-1, 405-2, 405-3, 405-4, 410-1, 410-2, 410-3, 410-4. The tiles 405-1, 405-2, 405-3, 405-4, 410-1, 410-2, 410-3, and 410-4 each have a tile size of 4×4 (as an example). FIGS. 4A-4D illustrate a different tile selection order than FIGS. 4E-4H. For example, tile 405-1 of FIG. 4A is in the upper left corner, then tile 405-2 of FIG. 4B is four (4) columns to the right, then tile 405-3 of FIG. 4C is four (4) columns to the right, and then tile 405-4 of FIG. 4D is four (4) rows down. For example, tile 410-1 of FIG. 4E is in the upper left corner, then tile 410-2 of FIG. 4F is two (2) columns to the right, then tile 410-3 of FIG. 4G is two (2) columns to the right, and then tile 410-4 of FIG. 4H is two (2) columns to the right. Each of these examples would continue in the tile selection order until the algorithm has been applied to all pixels in the frame or image.

Returning to FIG. 2, in an example implementation, the algorithm selected by the enhance algorithm module 205 can be based on two or more pixels in the tile. For example, the algorithm can be an averaging algorithm that averages the tile with the tile above and below (or to the left and right) or averages the tile with the tile above and below and to the left and right. In an example implementation, each tile can include an aggregate value for all of the pixels in the tile. The aggregate can be, for example, a sum of absolute values of the pixels. In an example implementation, the algorithm is applied to each element of the pixel (e.g., R, G, and B) or applied to a portion of the elements of the pixel (e.g., Y and U of a YUV format). In an example implementation, the algorithm can be applied to one channel at a time. For example, in a first iteration the algorithm can be applied to the Y (R) channel, in a second iteration the algorithm can be applied to the U (G) channel, and in a third iteration the algorithm can be applied to the V (B) channel. In an example implementation, the algorithm can be applied to the sharpening info on the luma-channel and similar sharpening can be done on the chromacity channels.

The delta module 210 can be configured to generate delta values 35 and base values 40 based on the modified image 30 generated by the enhance algorithm module 205 and the image 5. For example, the delta module 210 can be configured to subtract the image 5 from the modified image 30. The subtraction can be pixel-by-pixel subtraction. The result of the image 5 being subtracted from the modified image 30 can be the delta values 35 and the remainder can be the base values 40. In an example iteration, the output of the enhance algorithm module 205 can be used as the delta values 35. In other words, in an example implementation the delta module 210 can be bypassed because the algorithm used by the enhance algorithm module 205 can be configured to generate the delta values 35.

The weighting module 215 can be configured to apply a weight (e.g., multiply) to the delta values 35 or a portion of the delta values 35 to generate weighted delta values 37. For example, the weights can differ from a small range of values (e.g., [0.5, . . . , 2.0]). In an example implementation, a larger weight (e.g., 2.0) can be used where the delta value 35 indicating a difference between two or more pixels is small. Further, a small weight (e.g., 0.5) can be used where the delta value 35 is large. For example, if the delta value 35 is 0.25 or less: use weight 2.0, if the delta value 35 is 1.0: use weight 1.0, and if the delta value 35 is 4.0 or more: use weight 0.5 (a delta value 35 in-between can be interpolated). Alternatively, if the delta value 35 is greater than a threshold value (or more than one threshold value), for example, 8.0: use the delta value 35. In an example implementation, the weighted delta values 37 can be included with the compressed image 15. For example, the weighted delta values 37 can be included in a header of a data packet including the compressed image 15.

The summing module 220 can be configured to generate the enhanced image 10. For example, the summing module 220 can be configured to add the weighted delta values with the base values 40 to generate the enhanced image 10. The summing module 220 can do a pixel-by-pixel addition. The addition can be done on each element of the pixel (e.g., R, G, and B) or done on a portion of the elements of the pixel (e.g., Y and U of a YUV format). In an example implementation, the summing can be applied to one channel at a time. For example, in a first iteration the summing can be applied to the Y (R) channel, in a second iteration the summing can be applied to the U (G) channel, and in a third iteration the summing can be applied to the V (B) channel. In an example implementation, the summing can be applied to the sharpening info on the luma-channel and similar sharpening can be done on the chromacity channels.

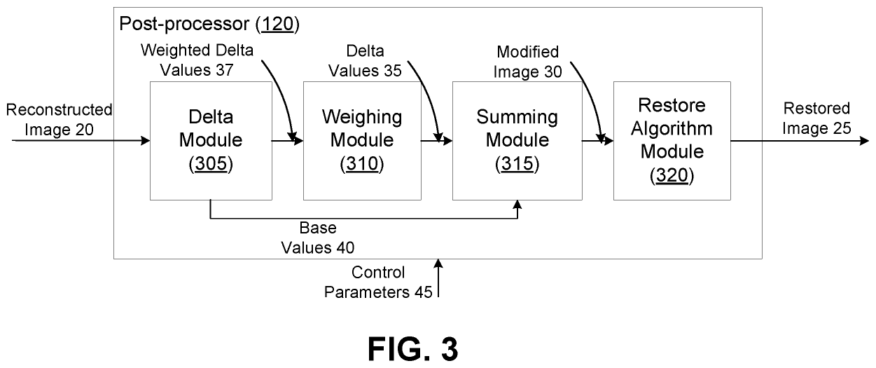

FIG. 3 illustrates the post-processor 120 according to an example implementation. As shown in FIG. 3, the post-processor 120 includes a delta module 305, a weighting module 310, a summing module 315, and a restore algorithm 320. Noting that references to a frame of video can also apply to an image and references to an image can also apply to a frame of video.

The delta module 305 can be configured to generate the delta values 35 and the base values 40 based on the reconstructed image 20. In an example implementation, the weighted delta values 37 can be included in a header of a data packet including the compressed image 15. Therefore, the weighted delta values 35 can be read from the data packet. The delta module 305 can be configured to subtract the weighted delta values 37 from the reconstructed image 20 to generate the base values 40. The subtraction can be pixel-by-pixel subtraction.

The weighting module 310 can be configured to apply a weight (e.g., multiply) to the weighted delta values 37 or a portion of the weighted delta values 37. For example, the weights can differ from a small range of values (e.g., [0.5, . . . , 2.0]). In an example implementation, the weights can be the opposite of the weights used by the weighting module 215. For example, if the weighted delta values 37 is 0.25 or less: use weight 0.5, if the weighted delta values 37 is 1.0: use weight 1.0, and if the weighted delta values 37 is 4.0 or more: use weight 2.5 (a delta value 35 in-between can be interpolated). Alternatively, if the weighted delta value 37 is greater than a threshold, for example, 8.0: use the weighted delta value 37. In other words, the weighting module 310 can perform the inverse of the weighting operation performed by the weighting module 215.

The summing module 315 can be configured to generate the modified image 30. For example, the summing module 315 can be configured to add the delta values 35 with the base values 40 to generate the modified image 30. The summing module 315 can do a pixel-by-pixel addition. The addition can be done on each element of the pixel (e.g., R, G, and B) or done on a portion of the elements of the pixel (e.g., Y and U of a YUV format). In an example implementation, the summing can be applied to one channel at a time. For example, in a first iteration the summing can be applied to the Y (R) channel, in a second iteration the summing can be applied to the U (G) channel, and in a third iteration the summing can be applied to the V (B) channel. In an example implementation, the summing can be applied to the sharpening info on the luma-channel and similar sharpening can be done on the chromacity channels.

The restore algorithm 320 can be configured to generate the restored image 25 based on the modified image 30. The restore algorithm 320 can be configured to perform the inverse operation of the enhance algorithm module 205. For example, the restore algorithm 320 can be configured to use a table, a simple algorithm (e.g., a delta algorithm, a gradient algorithm, a percentage algorithm, an add/subtract algorithm, a multiply/divide algorithm, and the like), a complex algorithm (e.g., a Laplacian algorithm). The table can be an inverse table, the simple algorithm can be an inverse simple algorithm (e.g., an inverse delta algorithm, an inverse gradient algorithm, an inverse percentage algorithm, an inverse add/subtract algorithm, an inverse multiply/divide algorithm, and the like), the complex algorithm can be an inverse complex algorithm (e.g., an inverse Laplacian algorithm) where inverse is the inverse of the table or algorithm used by the enhance algorithm module 205. The restore algorithm 320 can be configured to select a tile of pixels (e.g., a 4×4 tile, an 8×8 tile, . . . , a 32×32 tile and the like). The smaller the tile, the higher the quality of the restored image 25. For example, using a 2×2 tile should result in a higher quality restored image 25 than a 32×32 tile. The tile size should be the same tile size as used by the enhance algorithm module 205.

In an example implementation, the restore algorithm 320 selects an inverse algorithm (e.g., an inverse Laplacian algorithm) and a tile size (e.g., 4×4). Selecting the inverse algorithm and a tile size can be based on a control parameters 45 input. The control parameters 45 can include inverse algorithm, tile size, tile selection order, codec, and the like. The restore algorithm 320 then applies the inverse algorithm to each pixel in the tile. The restore algorithm 320 can apply the inverse algorithm in a row-to-row pattern, a column-to-column pattern, using a pyramid pattern (e.g., do all the pixels in the outermost square of pixels and sequentially move toward the center of the tile), in a zig-zag pattern, and the like.

The restore algorithm 320 can be configured to select the next tile based on a tile selection order. For example, referring to FIGS. 4A-4D, the tile selection order is illustrated as right-to-left and left-to-right order with no overlap. For example, referring to FIGS. 4E-4H, the tile selection order is illustrated as right-to-left with a two (2) column overlap. FIGS. 4A-4H each illustrate a portion of a frame or image each including a plurality of pixels (small squares). In other words, FIGS. 4A-4H can illustrate a sliding window or sliding tile window. The sliding window can be used to aggregate values calculated using the selected algorithm.

FIGS. 4A-4H also illustrate a tile 405-1, 405-2, 405-3, 405-4, 410-1, 410-2, 410-3, 410-4. The tiles 405-1, 405-2, 405-3, 405-4, 410-1, 410-2, 410-3, and 410-4 each have a tile size of 4×4 (as an example). FIGS. 4A-4D illustrate a different tile selection order than FIGS. 4E-4H. For example, tile 405-1 of FIG. 4A is in the upper left corner, then tile 405-2 of FIG. 4B is four (4) columns to the right, then tile 405-3 of FIG. 4C is four (4) columns to the right, and then tile 405-4 of FIG. 4D is four (4) rows down. For example, tile 410-1 of FIG. 4E is in the upper left corner, then tile 410-2 of FIG. 4F is two (2) columns to the right, then tile 410-3 of FIG. 4G is two (2) columns to the right, and then tile 410-4 of FIG. 4H is two (2) columns to the right. Each of these examples would continue in the tile selection order until the algorithm has been applied to all pixels in the frame or image.

Returning to FIG. 3, in an example implementation, the inverse algorithm selected by the restore algorithm 320 can be based on two or more pixels in the tile. For example, the inverse algorithm can be an averaging algorithm that averages the tile with the tile above and below (or to the left and right) or averages the tile with the tile above and below and to the left and right. In an example implementation, each tile can include an aggregate value for all of the pixels in the tile. The aggregate can be, for example, a sum of absolute values of the pixels. In an example implementation, the inverse algorithm is applied to each element of the pixel (e.g., R, G, and B) or applied to a portion of the elements of the pixel (e.g., Y and U of a YUV format).

In an example iteration, the output of the enhance algorithm module 205 can be used as the delta values 35. Therefore, the inverse algorithm selected by the restore algorithm 320 can be configured to generate the restored image 25 with the delta module 305 having been bypassed. In other words, the weighted delta values 37 can be generated, acquired, read, received, and the like without use of the delta module 305 and directly input to the weighting module 310.

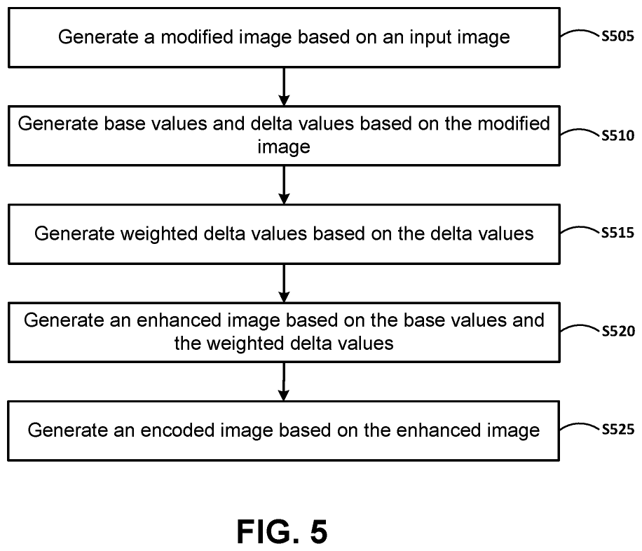

FIG. 5 illustrates a method for encoding an image according to an example implementation. Noting that references to a frame of video can also apply to an image and references to an image can also apply to a frame of video. As shown in FIG. 5, in step S505 a modified image is generated based on an input image. For example, an algorithm can be applied to each pixel in the input image. In an example implementation, the algorithm can be a table, a simple algorithm (e.g., a delta algorithm,), a complex algorithm (e.g., a Laplacian algorithm). In an example implementation, a tile of pixels (e.g., a 4×4 tile, an 8×8 tile, . . . , a 32×32 tile and the like) can be selected. The smaller the tile, the higher the quality of the restored image 25. For example, using a 2×2 tile should result in a higher quality restored image 25 than a 32×32 tile

In an example implementation, an algorithm (e.g., a Laplacian algorithm) and a tile size (e.g., 4×4) can be selected. Then the algorithm is applied to each pixel in the tile. The algorithm can be applied in a row-to-row pattern, a column-to-column pattern, using a pyramid pattern (e.g., do all the pixels in the outermost square of pixels and sequentially move toward the center of the tile), in a zig-zag pattern, and the like.

In step S510 base values and delta values are generated based on the modified image. For example, the input image can be subtracted from the modified image. The subtraction can be pixel-by-pixel subtraction The result of the input image being subtracted from the modified image can be the delta values and the remainder can be the base values.

In step S515 weighted delta values are generated based on the delta values. For example, a weight can be applied to the delta values or a portion of the delta values to generate weighted delta values. For example, the weights can differ from a small range of values (e.g., [0.5, . . . , 2.0]). In an example implementation, where the delta value is small, a larger weight (e.g., 2.0) can be used. Further, where the delta value is large, a small weight (e.g., 0.5) can be used. For example, if the delta value is 0.25 or less: use weight 2.0, if the delta value is 1.0: use weight 1.0, and if the delta value is 4.0 or more: use weight 0.5 (a delta value in-between can be interpolated). Alternatively, if the delta value is greater than a threshold value, for example, 8.0: use the delta value. In an example implementation, the weighted delta values can be included with a compressed image. For example, the weighted delta values can be included in a header of a data packet including the compressed image.

In step S520 an enhanced image is generated based on the base values and the weighted delta values. For example, the weighted delta values can be summed with the base values to generate the enhanced image. The summing can be a pixel-by-pixel addition. The addition can be done on each element of the pixel (e.g., R, G, and B) or done on a portion of the elements of the pixel (e.g., Y and U of a YUV format).

In step S525 an encoded image is generated based on the enhanced image. For example, an encoded or compressed image can be generated by compressing the enhanced image. In an example implementation, compressed the enhanced image can use any video or image encoder (e.g., JPEG, XYB-JPEG, WebP, AVIF, JPEG XL, AV1, and the like). In other words, compressing the enhanced image can be codec-agnostic.

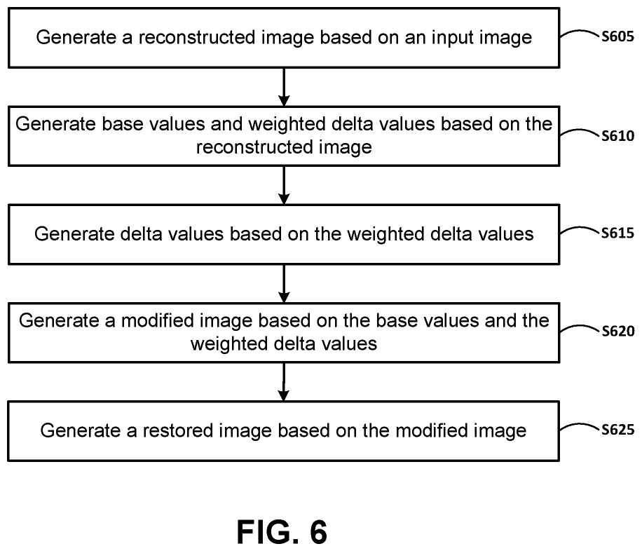

FIG. 6 illustrates a method for decoding an image according to an example implementation. Noting that references to a frame of video can also apply to an image and references to an image can also apply to a frame of video. As shown in FIG. 6, in step S605 a reconstructed image is generated based on an input image. For example, Foe example, the input image can be a compressed image. The input image can be decompressed using any video or image decoder (e.g., JPEG, XYB-JPEG, WebP, AVIF, JPEG XL, AV1, and the like). In other words, decompressing the input image can be codec-agnostic.

In step S610 base values and weighted delta values are generated based on the reconstructed image. For example, the weighted delta values can be subtracted from the modified image. The subtraction can be pixel-by-pixel subtraction The result of the weighted delta values being subtracted from the modified image can be the weighted delta values and the remainder can be the base values.

In step S615 delta values are generated based on the weighted delta values. For example, a weighting algorithm can be applied to the weighted delta values or a portion of the weighted delta values. For example, the weights can differ from a small range of values (e.g., [0.5, . . . , 2.0]). In an example implementation, the weights can be the opposite of the weights used in step S515. For example, if the weighted delta value is 0.25 or less: use weight 0.5, if the weighted delta value is 1.0: use weight 1.0, and if the weighted delta value is 4.0 or more: use weight 2.5 (a weighted delta value in-between can be interpolated). Alternatively, if the weighted delta value is greater than a threshold, for example, 8.0: use the weighted delta value. In other words, step S610 can perform the inverse of the weighting operation performed in step S515.

In step S620 a modified image is generated based on the base values and the weighted delta values. For example, the delta values can be summed with the base values to generate the modified image. The summing can be a pixel-by-pixel addition. The addition can be done on each element of the pixel (e.g., R, G, and B) or done on a portion of the elements of the pixel (e.g., Y and U of a YUV format).

In step S625 a restored image is generated based on the modified image. For example, an inverse algorithm can be applied to each pixel in the modified image. In other words, the restored image can be generated using the inverse operation of step S505. In an example implementation, the algorithm can be a table, a simple algorithm (e.g., a delta algorithm,), a complex algorithm (e.g., a Laplacian algorithm). The table can be an inverse table, the simple algorithm can be an inverse simple algorithm (e.g., an inverse delta algorithm, an inverse gradient algorithm, an inverse percentage algorithm, an inverse add/subtract algorithm, an inverse multiply/divide algorithm, and the like), the complex algorithm can be an inverse complex algorithm (e.g., an inverse Laplacian algorithm) where inverse is the inverse of the table or algorithm used by the enhance algorithm module 205. In an example implementation, a tile of pixels (e.g., a 4×4 tile, an 8×8 tile, . . . , a 32×32 tile and the like) can be selected. The smaller the tile, the higher the quality of the restored image 25. For example, using a 2×2 tile should result in a higher quality restored image 25 than a 32×32 tile. The tile size should be the same tile size as used in step S505.

In an example implementation, an inverse algorithm (e.g., an inverse Laplacian algorithm) and a tile size (e.g., 4×4) can be selected. Then the algorithm is applied to each pixel in the tile. The algorithm can be applied in a row-to-row pattern, a column-to-column pattern, using a pyramid pattern (e.g., do all the pixels in the outermost square of pixels and sequentially move toward the center of the tile), in a zig-zag pattern, and the like.

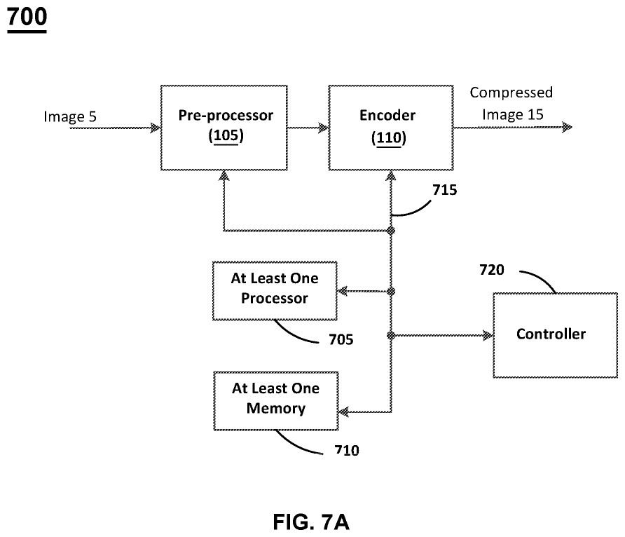

FIG. 7A illustrates a block diagram of an encoder (e.g., video and/or image) system according to an example implementation. Noting that references to a frame of video can also apply to an image and references to an image can also apply to a frame of video. In the example of FIG. 7A, an encoder system 700 may be at least one computing device and should be understood to represent virtually any computing device configured to perform the methods described herein. As such, the encoder system 700 may be understood to include various standard components which may be utilized to implement the techniques described herein, or different or future versions thereof.

FIG. 7A illustrates the encoder system 700 according to at least one example implementation. As shown in FIG. 7A, the encoder system 700 includes the at least one processor 705, the at least one memory 710, a controller 720, the pre-processor 105, and the encoder 110. The at least one processor 705, the at least one memory 710, the controller 720, the pre-processor 105, and the encoder 110 are communicatively coupled via bus 715.

Thus, as may be appreciated, the at least one processor 705 may be utilized to execute instructions stored on the at least one memory 710, so as to thereby implement the various features and functions described herein, or additional or alternative features and functions. Of course, the at least one processor 705 and the at least one memory 710 may be utilized for various other purposes. In particular, the at least one memory 710 may be understood to represent an example of various types of memory and related hardware and software which might be used to implement any one of the modules described herein.

The at least one processor 705 may be configured to execute computer instructions associated with the controller 720, pre-processor 105, and/or the encoder 110. The at least one processor 705 may be a shared resource. For example, the encoder system 700 may be an element of a larger system (e.g., a streaming server). Therefore, the at least one processor 705 may be configured to execute computer instructions associated with other elements (e.g., a streaming server streaming video) within the larger system.

The at least one memory 710 may be configured to store data and/or information associated with the encoder system 700. For example, the at least one memory 710 may be configured to store video codecs. The controller 720 may be configured to generate various control signals and communicate the control signals to various blocks in encoder system 700. The controller 720 may be configured to generate the control signals in accordance with the techniques described above.

FIG. 7B illustrates a block diagram of a decoder (e.g., a video and/or image) system according to an example implementation. Noting that references to a frame of video can also apply to an image and references to an image can also apply to a frame of video. In the example of FIG. 7B, a decoder system 750 may be at least one computing device and should be understood to represent virtually any computing device configured to perform the methods described herein. As such, the decoder system 750 may be understood to include various standard components which may be utilized to implement the techniques described herein, or different or future versions thereof. As shown in FIG. 7B, the decoder system 750 includes the at least one processor 755, the at least one memory 760, a controller 770, the decoder 115, and the post-processor 120. The at least one processor 755, the at least one memory 760, the controller 770, the decoder 115, and the post-processor 120 are communicatively coupled via bus 765.

The at least one processor 755 may be utilized to execute instructions stored on the at least one memory 760, so as to thereby implement the various features and functions described herein, or additional or alternative features and functions. The at least one processor 755 and the at least one memory 760 may be utilized for various other purposes. In particular, the at least one memory 760 may be understood to represent an example of various types of memory and related hardware and software which might be used to implement any one of the modules described herein. According to example implementations, the encoder system 700 and the decoder system 750 may be included in a same larger system. Further, the at least one processor 705 and the at least one processor 755 may be a same at least one processor and the at least one memory 710 and the at least one memory 760 may be a same at least one memory. Still further, the controller 720 and the controller 770 may be a same controller.

The at least one processor 755 may be configured to execute computer instructions associated with the controller 770, the decoder 115 and/or the post-processor 120. The at least one processor 755 may be a shared resource. For example, the decoder system 750 may be an element of a larger system (e.g., a mobile device). Therefore, the at least one processor 755 may be configured to execute computer instructions associated with other elements (e.g., web browsing or wireless communication) within the larger system.

The at least one memory 760 may be configured to store data and/or information associated with the decoder system 750. The controller 770 may be configured to generate various control signals and communicate the control signals to various blocks in the decoder system 750. The controller 770 may be configured to generate the control signals in accordance with the techniques described above.

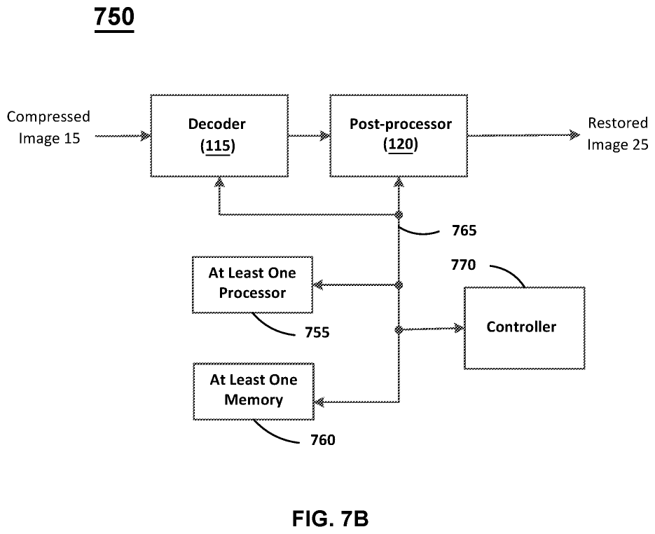

Example 1. FIG. 8 is a block diagram of a method of encoding video according to an example implementation. As shown in FIG. 8, in step S805 generate base values and delta values based on an image. In step S810 generate weighted delta values based on the delta values. In step S815 generate an enhanced image based on the base values and the weighted delta values. In step S820 compress the enhanced image.

Example 2. The method of Example 1 can further include applying an algorithm to each pixel of an input image to generate the image.

Example 3. The method of Example 2, wherein applying the algorithm to each pixel of the input image can include selecting a tile of pixels of the input image, applying the algorithm to a first portion of the pixels of the tile, and applying the algorithm to a second portion of the pixels of the tile.

Example 3A. The method of Example 2 can further include selecting at least two pixels in the tile of pixels as the first portion of the pixels and selecting at least two pixels in the tile of pixels as the second portion of the pixels.

Example 4. The method of Example 2, wherein applying the algorithm to each pixel of the input image can include selecting a tile of pixels of the input image and applying the algorithm to all of the pixels of the tile.

Example 5. The method of Example 2, wherein applying the algorithm to each pixel of the input image can include selecting a tile of pixels of the input image, applying the algorithm to all of the pixels of the tile, and assigning a value generated by the algorithm to each of the pixels of the tile.

Example 6. The method of Example 2, wherein the generating of the base values and the delta values can includes subtracting the input image from a result of applying the algorithm to each pixel of the input image, the subtraction being a pixel-by-pixel subtraction, and the delta values being the result of the subtraction.

Example 7. The method of Example 1, wherein the generating of the weighted delta values can include applying a weight to each of the delta values, wherein the weight is in a range of 0.5 to 2.0.

Example 8. The method of Example 1, wherein the generating of the weighted delta values can include applying a weight to the delta values having a value below a threshold value and assigning the delta values having a value above the threshold value as the weighted delta values.

Example 9. The method of Example 1, wherein the generating of the enhanced image can include summing the base values and the weighted delta values.

Example 10. The method of Example 1, wherein the compressing of the enhanced image can be codec-agnostic.

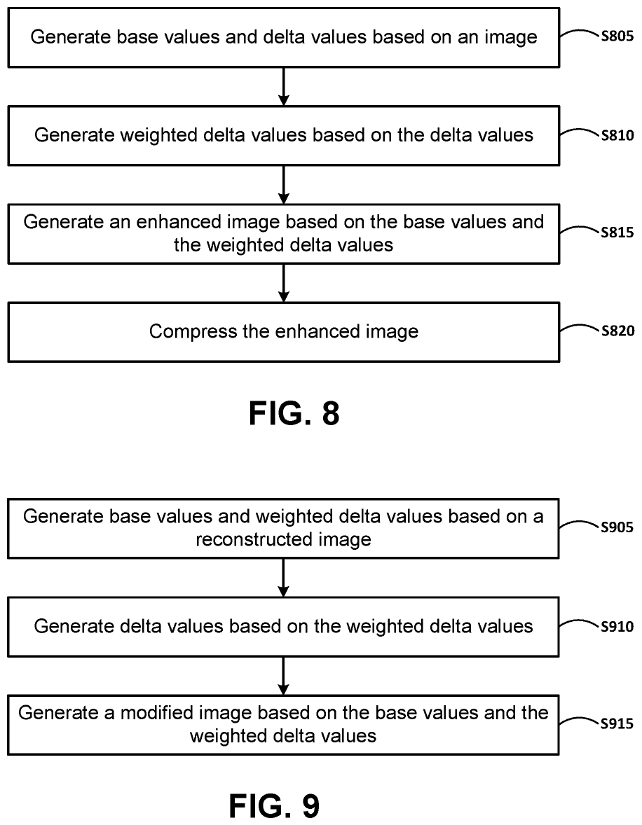

Example 11. FIG. 9 is a block diagram of a method of decoding video according to an example implementation. As shown in FIG. 9, in step S905 generate base values and weighted delta values based on a reconstructed image. In step S910 generate delta values based on the weighted delta values. In step S915 generate a modified image based on the base values and the delta values.

Example 12. The method of Example 11, wherein the generating of the delta values can include applying a weight to each of the weighted delta values, wherein the weight is in a range of 0.5 to 2.0.

Example 13. The method of Example 11, wherein the generating of the delta values can include applying a weight to the weighted delta values having a value below a threshold value and assigning the weighted delta values having a value above the threshold value as the delta values.

Example 14. The method of Example 11, wherein the generating of the modified image can include summing the base values and the delta values.

Example 15. The method of Example 11 can further include generating the reconstructed image by decompressing a compressed image.

Example 16. The method of Example 11 can further include generating a restored image based on the modified image using an algorithm applied to each pixel of the modified image.

Example 17. The method of Example 16, wherein the generating of the restored image can include selecting a tile of pixels of the modified image, applying the algorithm to a first portion of the pixels of the tile, and applying the algorithm to a second portion of the pixels of the tile.

Example 17A. The method of Example 17 can further include selecting at least two pixels in the tile of pixels as the first portion of the pixels and selecting at least two pixels in the tile of pixels as the second portion of the pixels

Example 18. The method of Example 16, wherein the generating of the restored image can include selecting a tile of pixels of the modified image and applying the algorithm to all of the pixels of the tile.

Example 19. A method can include any combination of one or more of Example 1 to Example 18.

Example 20. A non-transitory computer-readable storage medium comprising instructions stored thereon that, when executed by at least one processor, are configured to cause a computing system to perform the method of any of Examples 1-19.

Example 21. An apparatus comprising means for performing the method of any of Examples 1-19.

Example 22. An apparatus comprising at least one processor and at least one memory including computer program code, the at least one memory and the computer program code configured to, with the at least one processor, cause the apparatus at least to perform the method of any of Examples 1-19.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

1. A method comprising:
generating base values and delta values based on an image;
generating weighted delta values based on the delta values;
generating an enhanced image based on the base values and the weighted delta values; and
compressing the enhanced image.

2. The method of claim 1, further comprising applying an algorithm to each pixel of an input image to generate the image.

3. The method of claim 2, wherein applying the algorithm to each pixel of the input image comprises:
selecting a tile of pixels of the input image;
applying the algorithm to a first portion of the pixels of the tile; and
applying the algorithm to a second portion of the pixels of the tile.

4. The method of claim 3, further comprising:
selecting at least two pixels in the tile of pixels as the first portion of the pixels; and
selecting at least two pixels in the tile of pixels as the second portion of the pixels.

5. The method of claim 2, wherein applying the algorithm to each pixel of the input image comprises:
selecting a tile of pixels of the input image; and
applying the algorithm to all of the pixels of the tile to generate one of the delta values.

6. The method of claim 2, wherein applying the algorithm to each pixel of the input image comprises:
selecting a tile of pixels of the input image;
applying the algorithm to all of the pixels of the tile; and
assigning a value generated by the algorithm to each of the pixels of the tile.

7. The method of claim 2, wherein the generating of the base values and the delta values comprises:
subtracting the input image from a result of applying the algorithm to each pixel of the input image;
the subtraction being a pixel-by-pixel subtraction; and
the delta values being a result of the subtraction.

8. The method of claim 1, wherein the generating of the weighted delta values comprises:
applying a weight to each of the delta values, wherein the weight is in a range of 0.5 to 2.0.

9. The method of claim 1, wherein the generating of the weighted delta values comprises:
applying a weight to the delta values having a value below a threshold value; and
assigning the delta values having a value above the threshold value as the weighted delta values.

10. The method of claim 1, wherein the generating of the enhanced image comprises summing the base values and the weighted delta values.

11. The method of claim 1, wherein the compressing of the enhanced image is codec-agnostic.

12. A method comprising:
generating base values and weighted delta values based on a reconstructed image;
generating delta values based on the weighted delta values; and
generating a modified image based on the base values and the delta values.

13. The method of claim 12, wherein the generating of the delta values comprises:
applying a weight to each of the weighted delta values, wherein the weight is in a range of 0.5 to 2.0.

14. The method of claim 12, wherein the generating of the delta values comprises:
applying a weight to the weighted delta values having a value below a threshold value; and
assigning the weighted delta values having a value above the threshold value as the delta values.

15. The method of claim 12, wherein the generating of the modified image comprises summing the base values and the delta values.

16. The method of claim 12, further comprising generating the reconstructed image by decompressing a compressed image.

17. The method of claim 12, further comprising:
generating a restored image based on the modified image using an algorithm applied to each pixel of the modified image.

18. The method of claim 17, wherein the generating of the restored image comprises:
selecting a tile of pixels of the modified image;
applying the algorithm to a first portion of the pixels of the tile; and
applying the algorithm to a second portion of the pixels of the tile.

19. The method of claim 18, further comprising:
selecting at least two pixels in the tile of pixels as the first portion of the pixels; and
selecting at least two pixels in the tile of pixels as the second portion of the pixels.

20. The method of claim 18, wherein the generating of the restored image comprises:
selecting a tile of pixels of the modified image; and
assigning a value generated by the algorithm to each of the pixels of the tile.

21-40. (canceled)
